(19) United States
(12) Patent Application Publication
(10) Pub. No.: US 2021/0256511 A1
(43) Pub. Date: Aug. 19, 2021

(54) SYSTEMS AND METHODS FOR FACILITATING TRANSACTIONS

(71) Applicant: SOS Solutions, lnc., Tonasket, WA (US)

(72) Inventors: Samuel R. Peacemaker, Gilbert, AZ (US); Benjamin Peacemaker, Chandler, AZ (US)

(73) Assignee: SOS Solutions, lnc., Tonasket, WA (US)

(21) Appl. No.: 17/173,825

(22) Filed: Feb. 11, 2021

Related U.S. Application Data
(60) Provisional application No. 62/976,794, filed on Feb. 14, 2020.

(51) Int. Cl. G06Q 20/38; G06Q 20/40

(52) U.S. Cl. CPC G06Q 20/383; G06Q 20/385; G06Q 20/40

(57) ABSTRACT

A method is provided comprising receiving, at a privacy enhanced ordering system, a handle, authenticating, by the privacy enhanced ordering system, the handle, and sending, by the privacy enhanced ordering system, payment authorization data associated with the handle. A method is provided comprising receiving, at a privacy enhanced ordering system, a handle, authenticating, by the privacy enhanced ordering system, the handle, processing, by the privacy enhanced ordering system, payment in response to the authentication, sending, by the privacy enhanced ordering system, payment. A method is provided comprising receiving, at a merchant device, a handle, sending, by the merchant device and to a privacy enhanced ordering system, the handle, receiving, by the merchant device, authorization data from the privacy enhanced ordering system, transmitting, by the merchant device, data associated with the handle to a shipper.

### CROSS REFERENCE TO RELATED APPLICATIONS

This application is a nonprovisional of, and claims priority to, U.S. Provisional Application No. 62/976,794, entitled “SYSTEMS AND METHODS FOR FACILITATING TRANSACTIONS” and filed on Feb. 14, 2020, which is hereby incorporated by reference for all purposes.

### FIELD

The present disclosure generally relates to systems and methods for facilitating transactions.

### BACKGROUND

Consumer transactions occur online via eCommerce, in traditional brick and mortar stores, and in peer to peer environments where one consumer purchases goods or services from another consumer in a private sale. Though payment via cash provides anonymity and thus safety from identify theft and other potential crimes, tangible cash (i.e., paper bills and metallic coins) are bulky, difficult to produce for electronic payments, and are otherwise inconvenient. Prior systems have tried to make payments for online goods and services quick and convenient but have significant shortcomings. For instance, typical eCommerce “one click” checkout systems such as those offered by Amazon, Inc. may provide a fast convenient way to purchase items from an eCommerce store. However, in order for this one click ordering system to work, users must create an account on the website/online/eCommerce store that they intend to purchase items or services from and add all their sensitive credit card and personal data on that website in order to place a one click order in the future. This limits the convenience of one click purchases to only the websites/eCommerce stores that the consumer has created accounts with and must entrust to hold safe their sensitive data, thereby causing consumers to increase exposure to a data breach by having users place sensitive information in a number of places.

Consumers that shop on websites/eCommerce stores that accept payment services such as that offered by PayPal must provide their name and shipping information in most cases before they are taken to the payment service portal. The payment service portal then must ask the user to login to verify the transaction. Filling out this information for every transaction is inconvenient for the consumer and can be time consuming.

These and other payment transaction systems and methods expose consumer information such as the consumers name, credit card information, personal email address, phone number, and home or office address that may compromise the consumers safety.

Moreover, for online transactions, consumers typically provide a shipping address to which a merchant may ship a package. This exposes consumer information, such as a home or office address, that may compromise the consumer's safety. In that regard, the area of facilitating transactions has this, and other, areas upon which to improve.

### SUMMARY

A method is provided comprising receiving, at a privacy enhanced ordering system, a handle, authenticating, by the privacy enhanced ordering system, the handle, and sending, by the privacy enhanced ordering system, payment authorization data associated with the handle.

A method is provided comprising receiving, at a privacy enhanced ordering system, a handle, authenticating, by the privacy enhanced ordering system, the handle, processing, by the privacy enhanced ordering system, payment in response to the authentication, sending, by the privacy enhanced ordering system, payment.

A method is provided comprising receiving, at a merchant device, a handle, sending, by the merchant device and to a privacy enhanced ordering system, the handle, receiving, by the merchant device, authorization data from the privacy enhanced ordering system, transmitting, by the merchant device, data associated with the handle to a shipper.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 shows a privacy enhanced ordering distributed system, in accordance with various embodiments;

FIG. 2 shows a privacy enhanced ordering method, in accordance with various embodiments;

FIG. 3 shows a privacy enhanced ordering distributed system, in accordance with various embodiments;

FIG. 4 shows a privacy enhanced ordering method, in accordance with various embodiments;

FIG. 5 shows a privacy enhanced ordering distributed system, in accordance with various embodiments;

FIG. 6 shows privacy enhanced ordering method, in accordance with various embodiments;

FIG. 7 shows a privacy enhanced ordering distributed system, in accordance with various embodiments; and

FIG. 8 shows a privacy enhanced ordering method, in accordance with various embodiments;

### DETAILED DESCRIPTION

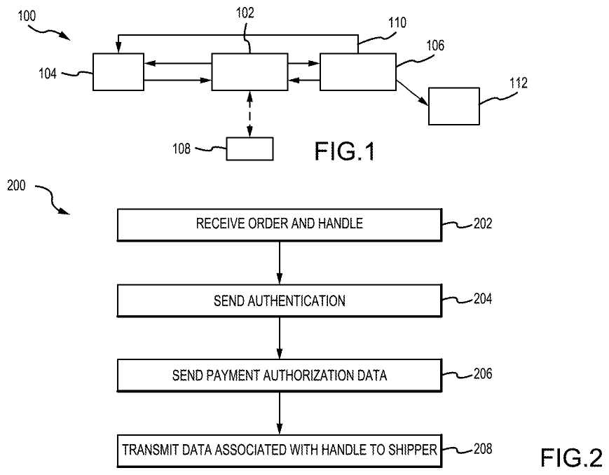

With reference to FIGS. 1-2, privacy enhanced ordering distributed system 100 is illustrated with method 200. In privacy enhanced ordering distributed system 100, privacy enhanced ordering system 102 is shown in communication with shipper 104 and merchant 106. User device 108 may input a handle into privacy enhanced ordering system 102, along with a preferred shipping address and payment information such as credit card/gift card/transaction card/eWallet/cryptocurrency keys.

The handle may be any suitable identifier for user device 108. In various embodiments, the handle comprises at least one of a text string (for example, text containing American Standard Code for Information Interchange (“ASCII”) characters), a bar code, a Quick Response (“QR”), and/or alphanumeric characters. The handle may comprise an email address, a username, or other arrangement of alphanumeric characters. The handle may be encrypted, though in various embodiments the handle is not encrypted.

Privacy enhanced ordering system 102 maintains a database or other data structure that maps the handle to at least one of a shipping address, a billing address, payment information such as information relating to credit card/gift card/transaction card/eWallet/cryptocurrency keys, a phone number, email address, and/or an authentication mechanism such as a multi-factor authentication system (“MFA”).

Privacy enhanced ordering system 102 may arrange for an authentication mechanism between privacy enhanced ordering system 102 and user device 108. The authentication mechanism may include an authentication communication that may comprise a phone call, fax, text message, an in-app notification or the like. The user device 108 may also arrange for secondary indicia of verification, such as a verification code such as a code generated by a Time-based One-time Password Algorithm or other authentication factor as supported by a MFA. The merchant 106 may receive an order indicating an item to be purchased and the handle comprising one or more alphanumeric characters (step 202). The handle may comprise an email address so that merchant 106 may update the user device 108 on order processing events such as shipping date, tracking number, and expected delivery date. However, in various embodiments, an email address associated with user device 108 can be provided to the merchant along with payment authorization, as described herein. In that regard, the handle can, but in various embodiments does not, comprise an email address. In various embodiments, the email address given to the merchant 106 is associated with the privacy enhanced ordering system 102, for example, the email address could have the same domain name as privacy enhanced ordering system 102. In this manner, by not exposing a personal email address associated with user device 108, further privacy and security is achieved. In various embodiments, privacy enhanced ordering system 102 may forward emails from the merchant 106 to the user device 108 by forwarding to a personal or business email address associated with user device 108. In various embodiments, privacy enhanced ordering system 102 may host an email system (for example, with support for POP/POP3, IMAP, SMTP, or web-based interfaces, etc) to display emails sent by merchant 106 to the user device 108.

During order processing, merchant 106 may send the handle for authentication (step 204) to privacy enhanced ordering system 102. Authentication (step 204) comprises one or more verification processes to authenticate user device 108 such that merchant 106 may proceed with the order. To that end, privacy enhanced ordering system 102 may send one or more authentication communications to the owner of the handle, for example, by sending one or more authentication communications to user device 108. The one or more authentication communications act to serve as verification to support the authentication of user device 108. The authentication communication may be a phone call, fax, text message, an in-app notification or the like, as described above. The owner of the handle may then approve the transaction via voice, text or in-app selection. Moreover, privacy enhanced ordering system 102 may solicit, and user device 108 may provide, secondary indicia of verification, for example via input of a verification code such as a code generated by a Time-based One-time Password Algorithm. The secondary indicia of verification may be facilitated using a biometric marker (e.g., fingerprint, facial recognition, or other marker derived from a biological trait). By using multi-factored authentication, the risk of fraud and abuse may be decreased.

Once privacy enhanced ordering system 102 has authentication, privacy enhanced ordering system 102 may pass payment authorization data, including payment data, to merchant 106. The payment data may include credit card information (e.g., account number, expiration date, CCV code), though the payment data may include a onetime only use transaction card number (e.g., a credit card number, a stored value card number, or a debit card number) and not an account number, in various embodiments. The onetime use credit card number may be a number supplied by privacy enhanced ordering system 102, for example one generated with the assistance of a transaction card account provider (e.g., a bank), that is associated with a single use, and in various embodiments, is associated with a predetermined amount. In various embodiments, privacy enhanced ordering system 102 may pass another form of payment to merchant 106. For example, privacy enhanced ordering system 102 may facilitate a cryptocurrency exchange in favor of the merchant and/or pass a gift card account number or other code that is associated with a gift card issued by the merchant 106. In this regard, payment authorization data may include authorization to perform a cryptocurrency exchange.

In this manner, privacy enhanced ordering system 102 provides merchant 106 with payment data and merchant 106 passes the payment data to merchant 106's payment acquirer 112. Payment acquirer 112 may then process the payment. However, where privacy enhanced ordering system 102 passes gift card information, merchant 106 may internally process such transaction or refer the transaction to a third party that processes gift card transactions.

Once payment is processed, merchant 106 may present a product packaged for delivery to shipper 104. Merchant 106 may pass the handle to shipper 104, whether electronically or via a paper shipping label. Shipper 104 then may retrieve the shipping addresses associated with the handle from privacy enhanced ordering system 102 in step 208. Shipper 104 may then process the package for shipping. In various embodiments, once payment is processed, merchant 106 may print a shipping label from shipper 104 (via, for example, a portal/website) with the shipping label displaying only the handle along with a QR code or other scannable code of the like that hides the shipping address and other info from being viewed. The QR code may encode a token, hash, or similar data construct that would allow the shipper 104 to decode the shipping address information and label the package with this shipping address during package processing. In this regard, shipper 104 may input the handle and/or QR code, retrieve the shipping address from privacy enhanced ordering system 102, and print a label for affixing to the package that contains the shipping address.

In this manner, using only the handle and/or QR code to pass to the merchant 106 and payment acquirer 112, the privacy of a user's shipping address and form of payment is protected from the merchant 106 and the payment acquirer 112. This reduces the susceptibility to fraud, as merchant does not necessarily receive reusable payment data that may be potentially misappropriated.

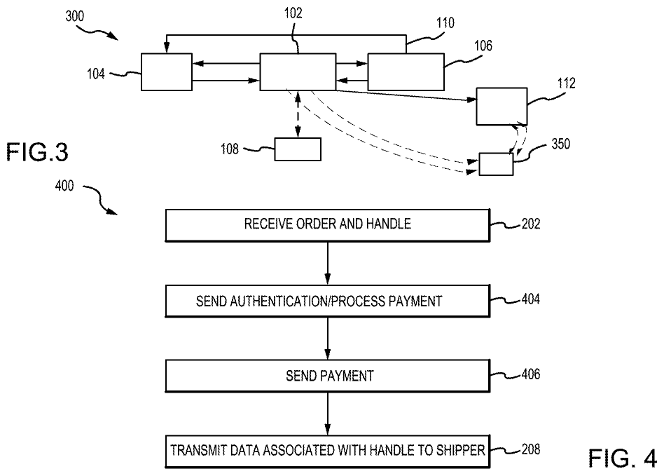

With reference to FIGS. 3-4, privacy enhanced ordering distributed system 300 is illustrated with method 400. Privacy enhanced ordering distributed system 300 and privacy enhanced ordering distributed system 100 are the same, as are method 200 and method 400, except where noted and shown herein.

In various embodiments, privacy enhanced ordering system 102 may process payment (step 404) provide merchant 106 with payment directly (step 406). For example, in various embodiments, privacy enhanced ordering system 102 may pass payment information to payment acquirer 112 and, in turn, receive funds to pass to merchant 106 (step 404). In this manner, merchant 106 may retrieve payment directly from privacy enhanced ordering system 102 via wire transfer, electronic funds transfer, check, cryptocurrency exchange, or other payment system such as an instant payment system (e.g., ZELLE). In various embodiments, privacy enhanced ordering system 102 may provide merchant 106 with a credit on an internal ledger of privacy enhanced ordering system 102. Merchant 106 may then retrieve payment via a mutually acceptable vehicle (step 406).

In various embodiments, privacy enhanced ordering system 102 may interact with a distributed ledger 350. Distributed ledger systems provide a decentralized database that is consensually shared and synchronized without a central administrator or intermediate party. The decentralized database may exist across several locations and/or among multiple participants. The distributed ledger system may process, validate, and/or authenticate writes and data exchanges to the decentralized database. For example, in a blockchain implementation, the system may provide features and functionality including consensus-based validation, immutability, and cryptographically chained blocks of data.

The distributed ledger may use features and functionality of blockchain technology including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The blockchain may be based on any blockchain technology such as, for example, ETHEREUM®, OPENCHAIN®, Chain Open Standard technology, HYPERLEDGER® Fabric, CORDA®, Connect™, Sawtooth™, etc. The blockchain may comprise a system of blocks containing data that are interconnected by reference to the previous block. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of privacy enhanced ordering system 102, the blockchain may serve as an immutable log for the deployment of cloud-based systems and related contracts, cryptocurrency exchanges and processes.

In that regard, privacy enhanced ordering system 102 may initiate a cryptocurrency exchange in favor of merchant 106 via distributed ledger 350. Distributed ledger 350 may record the transfer from privacy enhanced ordering system 102 to merchant 106, thus acting to transfer payment to merchant 106.

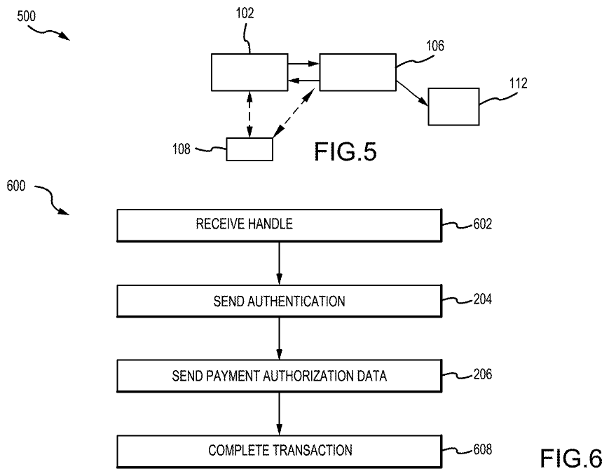

With reference to FIGS. 5-6, privacy enhanced ordering distributed system 500 is illustrated with method 600. Privacy enhanced ordering distributed system 500 and privacy enhanced ordering distributed system 100 are the same, as are method 200 and method 600, except where noted and shown herein.

In method 600, privacy enhanced ordering distributed system 500 facilitates a transaction at a traditional point of sale, such as at a “brick and mortar” store or in a peer to peer/shared payments environment. In that regard, the shipping process may not be utilized. However, consumer privacy is still a concern. Many retailers retain credit card information, which from time to time is breached by hackers, disgruntled employees, or the like. In that regard, use of a more private and/or secure system is beneficial.

Merchant 106 may receive handle from user device 108 (step 602). The handle may be entered at a point of sale device manually, encoded and scanned in a QR code or bar code displayed on user device 108, transmitted by user device 108 via Bluetooth, NFC, or a network connection, as described herein below, to point of sale device of merchant 106. The point of sale device may comprise a traditional point of sale device or a device such as a phone or tablet running software to act as a point of sale (e.g., through point of sale software such as that offered by SQUARE). The point of sale device may also comprise a phone or tablet running an application to act as a payment acceptor in a peer to peer environment (e.g that offered by VENMO). The point of sale device may also comprise a standalone terminal or kiosk in a self-serve/self-pay environment. Privacy enhanced ordering distributed system 500 may then proceed with steps 204 and 206, as described above. Notably, during step 204 and as described above, user device may display a Time-based One-time Password Algorithm for input into a point of sale device of merchant 106 (again, via, for example, manual input, encoded and scanned in a QR code or bar code displayed on user device 108, and/or Bluetooth, NFC, or a network connection), which may be beneficial in circumstances where user device 108 may experience network connectivity issues. In step 608, the transaction is otherwise completed with the consumer.

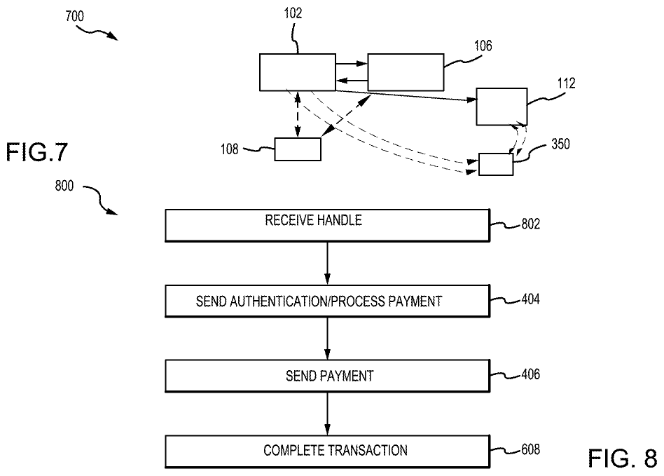

With reference to FIGS. 7-8, privacy enhanced ordering distributed system 700 is illustrated with method 800. Privacy enhanced ordering distributed system 700 and privacy enhanced ordering distributed system 300 are the same, as are method 400 and method 800, except where noted and shown herein.

In method 800, privacy enhanced ordering distributed system 700 facilitates a transaction at a traditional point of sale, such as at a “brick and mortar” store or in a peer to peer/shared payments environment. In that regard, the shipping process may not be utilized. However, consumer privacy is still a concern. Many retailers retain credit card information, which from time to time is breached by hackers, disgruntled employees, or the like. In that regard, use of a more private and/or secure system is beneficial. Moreover, especially in peer to peer environments, access to payment acquirers may be uncommon or difficult to obtain. Thus, it may be beneficial for privacy enhanced ordering system 702 to facilitate payment.

Merchant 106 may receive handle from user device 108 (step 802). The handle may be entered at a point of sale device manually, encoded and scanned in a QR code or bar code displayed on user device 108, transmitted by user device 108 via Bluetooth, NFC, or a network connection, as described herein below, to point of sale device of merchant 106. The point of sale device may comprise a traditional point of sale device or a device such as a phone or tablet running software to act as a point of sale (e.g., through point of sale software such as that offered by SQUARE). The point of sale device may also comprise a phone or tablet running an application to act as a payment acceptor in a peer to peer environment (e.g that offered by VENMO). The point of sale device may also comprise a standalone terminal or kiosk in a self-serve/self-pay environment. Privacy enhanced ordering distributed system 500 may then proceed with steps 404 and 406, as described above. Notably, during step 404 and as described above, user device may display a Time-based One-time Password Algorithm for input into a point of sale device of merchant 106 (again, via, for example, manual input, encoded and scanned in a QR code or bar code displayed on user device 108, and/or Bluetooth, NFC, or a network connection), which may be beneficial in circumstances where user device 108 may experience network connectivity issues. In step 608, the transaction is otherwise completed with the consumer.

Systems and methods in various embodiments may provide enhanced privacy and security. Instead of storing personal information across many merchant web sites, all of which are susceptible to a data breach, a consumer may store information with one or a few privacy enhanced ordering systems. Transactions are thus facilitated with merchants without the exchange of sensitive, private information that may cause the consumer to be susceptible to fraud or abuse should such sensitive, private information (e.g., home address, credit card number, business address, etc.) fall into the hands of a criminal actor. Moreover, the ease of transaction is facilitated in that simple, secure verification processes may be used to authenticate transactions. No longer will consumer need to create user “accounts” with many online retailers to purchase goods and services. Even in the peer to peer environment, value (such as currency or cryptocurrency) can be exchanged quickly and easily while keeping sensitive information secure.

The technologies described herein may be incorporated into any of the components, devices, and systems described herein.

In various embodiments, merchant 106, user device 108, payment acquirer 112, privacy enhanced ordering systems, and other systems may incorporate hardware and/or software components. For example, a web client running on a merchant device, user device, payment acquirer, privacy enhanced ordering distributed systems, or the like may comprise a server appliance running a suitable server operating system (e.g., MICROSOFT INTERNET INFORMATION SERVICES or, “IIS”). Web client 150 may be any device that allows a user to communicate with a network (e.g., a personal computer, personal digital assistant (e.g., IPHONE®, BLACKBERRY®), tablet, cellular phone, kiosk, and/or the like). De includes any device (e.g., personal computer, mobile device, etc.) which communicates via any network, for example such as those discussed herein. In various embodiments, merchant 106, user device 108, payment acquirer 112, privacy enhanced ordering distributed systems, and other systems may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a payment form and (ii) an address. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

For example, merchant 106, user device 108, payment acquirer 112 may comprise a server appliance running a suitable server operating system (e.g., MICROSOFT INTERNET INFORMATION SERVICES or, “IIS”) and having database software (e.g., ORACLE) installed thereon. Merchant 106, user device 108, payment acquirer 112, privacy enhanced ordering distributed systems, may be in electronic communication with one another, either directly or through various intermediaries and/or networks.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

An online merchant, as used herein, may also be an online marketplace. An online marketplace may be an online seller of goods and services that sells both goods and services from its own inventory and from the inventory of other sellers that have access to the online marketplace.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: gift card data, transaction card data, credit card data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones. Gifts as disclosed herein may include subscriptions or upgrades within the distribution channels.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf, which is hereby incorporated by reference in its entirety.

In various embodiments, the system and various components may integrate with one or more smart digital assistant technologies. For example, exemplary smart digital assistant technologies may include the ALEXA system developed by AMAZON®, GOOGLE HOME®, APPLE® HOMEPOD®, and/or similar digital assistant technologies. AMAZON® ALEXA, GOOGLE HOME®, and APPLE® HOMEPOD®, may each provide cloud-based voice activation services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPOD® systems may receive voice commands via its voice activation technology, and activate other functions, control smart devices, and/or gather information. For example, the smart digital assistant technologies may be used to interact with music, emails, texts, calling, question answering, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPOD® systems may also allow the user to access information about eligible transaction accounts linked to an online account across all digital assistant-enabled devices.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g., WEB SPHERE®, WEBLOGIC JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems, etc.).

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, integrated into any other application server components, reside within another computing device, or take the form of a standalone hardware component.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

As will be appreciated by one of ordinary skill in the art, the system or any of its components may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection. All gift facilitation systems, online merchants, merchant 106, user device 108, payment acquirer 112, privacy enhanced ordering distributed systems, shippers, and the like may be in electronic communication with one another.

As used herein, “transmit” may include sending electronic data from one system component to another over a network connection. Additionally, as used herein, “data” or “information” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, at a privacy enhanced ordering system, a handle;
authenticating, by the privacy enhanced ordering system, the handle;
sending, by the privacy enhanced ordering system, payment authorization data associated with the handle.

2. The method of claim 1, wherein the authenticating comprises sending, by the privacy enhanced ordering system, an authentication communication to a user device associated with the handle, the authentication communication comprising at least one of a phone call, a fax, a text message, and an in-app notification.

3. The method of claim 1, wherein the authenticating comprises requesting, by the privacy enhanced ordering system, a code generated by a Time-based One-time Password Algorithm to a user device associated with the handle.

4. The method of claim 2, wherein the authenticating further comprises requesting, by the privacy enhanced ordering system, a secondary indicator of verification to the user device associated with the handle, wherein the secondary indicator is a biometric marker.

5. The method of claim 1, wherein the payment authorization data comprises at least one of a onetime use transaction card number and an authorization to perform a cryptocurrency exchange.

6. The method of claim 1, wherein the sending further comprises providing, by the privacy enhanced ordering system, the payment authorization data to a payment acquirer.

7. The method of claim 1, further comprising sending, by the privacy enhanced ordering system, payment to a merchant.

8. An article of manufacture comprising:
a non-transitory, machine-readable memory having instructions recorded thereon that, in response to execution by a privacy enhanced ordering system, cause the privacy enhanced ordering system to perform operations comprising:
receiving, at the privacy enhanced ordering system, a handle;
authenticating, by the privacy enhanced ordering system, the handle;
sending, by the privacy enhanced ordering system, payment authorization data associated with the handle.

9. The article of manufacture of claim 8, wherein the authenticating comprises sending, by the privacy enhanced ordering system, an authentication communication to a user device associated with the handle, the authentication communication comprising at least one of a phone call, a fax, a text message, and an in-app notification.

10. The article of manufacture of claim 8, wherein the authenticating comprises requesting, by the privacy enhanced ordering system, a code generated by a Time-based One-time Password Algorithm to a user device associated with the handle.

11. The article of manufacture of claim 9, wherein the authenticating further comprises requesting, by the privacy enhanced ordering system, a secondary indicator of verification to the user device associated with the handle, wherein the secondary indicator is a biometric marker.

12. The article of manufacture of claim 8, wherein the payment authorization data comprises at least one of a onetime use transaction card number and an authorization to perform a cryptocurrency exchange.

13. The article of manufacture of claim 8, wherein the sending further comprises providing, by the privacy enhanced ordering system, the payment authorization data to a payment acquirer.

14. The article of manufacture of claim 8, wherein the operations further comprise sending, by the privacy enhanced ordering system, payment to a merchant.

15. A system comprising:
a privacy enhanced ordering system; and
a non-transitory, machine-readable memory in communication with the privacy enhanced ordering system having instructions recorded thereon that, in response to execution by the privacy enhanced ordering system, cause the privacy enhanced ordering system to perform operations comprising:
receiving, at the privacy enhanced ordering system, a handle;
authenticating, by the privacy enhanced ordering system, the handle;
sending, by the privacy enhanced ordering system, payment authorization data associated with the handle.

16. The system of claim 15, wherein the authenticating comprises sending, by the privacy enhanced ordering system, an authentication communication to a user device associated with the handle, the authentication communication comprising at least one of a phone call, a fax, a text message, and an in-app notification.

17. The system of claim 15, wherein the authenticating comprises requesting, by the privacy enhanced ordering system, a code generated by a Time-based One-time Password Algorithm to a user device associated with the handle.

18. The system of claim 16, wherein the authenticating further comprises requesting, by the privacy enhanced ordering system, a secondary indicator of verification to the user device associated with the handle, wherein the secondary indicator is a biometric marker.

19. The system of claim 15, wherein the payment authorization data comprises at least one of a onetime use transaction card number and an authorization to perform a cryptocurrency exchange.

20. The system of claim 15, wherein the sending further comprises providing, by the privacy enhanced ordering system, the payment authorization data to a payment acquirer.
